(19) United States
(12) Patent Application Publication
(10) Pub. No.: US 2022/0049198 A1
(43) Pub. Date: Feb. 17, 2022

(54) SYSTEM & METHOD FOR THE RAPID AGING OF A DISTILLED ETHYL ALCOHOL WITH RF ENERGY

(71) Applicant: RF Kettle Company, LLC, Fletcher, NC (US)

(72) Inventors: KEITH A. MORT, Fletcher, NC (US); CHADWICK E. SLAGLE, Black Mountain, NC (US)

(73) Assignee: RF Kettle Company, LLC, Fletcher, NC (US)

(21) Appl. No.: 17/516,544

(22) Filed: Nov. 1, 2021

Related U.S. Application Data
(63) Continuation of application No. 14/160,017, filed on Jan. 21, 2014.

(51) Int. Cl. C12H 6/02; H05B 6/80; H05B 6/68; C12H 1/16; C12G 3/07

(52) U.S. Cl. CPC C12H 6/02; H05B 6/802; Y02B 40/00; C12H 1/165; C12G 3/07; H05B 6/68

(57) ABSTRACT

Provided is a system and method for rapid aging of a distilled ethyl alcohol. The system includes a vessel having at least one aperture suitable for the introduction of radio frequency (RF) energy at a preselected frequency selected to pass through transparent material and be absorbed by opaque material. The vessel has at least one liquid circulating system to circulate liquid from a lower portion of the vessel to an upper portion of the vessel. An RF generator provides the predetermined frequency by way of a waveguide to the aperture of the vessel. An oxygenator is provided to dispose oxygen within a liquid disposed within the vessel and outgas congeners from the liquid, the vessel further providing at least one vent structured and arranged to vent the outgassed congeners. An associated method of use is also disclosed.

### CROSS-REFERENCE TO RELATED APPLICATIONS

The present application is a Continuation in Part of U.S. patent application Ser. No. 14/160,017 filed Jan. 21, 2014 and entitled METHOD AND ARRANGEMENT FOR HEATING OF LIQUIDS VIA RF ENERGY, the disclosure of which is incorporated herein by reference. Moreover, this Continuation in Part application claims the benefit of the filing date of U.S. patent application Ser. No. 14/160,017 filed Jan. 21, 2014.

### FIELD OF THE INVENTION

The present invention relates generally to systems and methods rapidly aging alcoholic beverages, and most specifically the rapid aging of distilled spirits.

### BACKGROUND

Distilled spirits, such as brandy, bourbon, scotch, gin, tequila, rum, whiskey, and the like are traditionally produced by distilling batches of fermented liquid to recover the ethanol and produce a raw liquid, which in turn is then aged in wooden vessels or vessels with wooden chips for years, if not even decades. The varieties of wood, such as oak (American/European/Sessile/Mongolian/etc. . . . ), cherry, maple, ash, etc. . . . are often selected for the flavor elements that they will impart to the raw liquid during the aging process.

Although the raw liquid—also known as distilled ethyl alcohol—may be consumed in an “as is” state, it is rarely marketed as such. Indeed, the aging process has been found and appreciated to be beneficial for the enhancement of flavor, color and aroma. These improvements are so significant that great investments of time and money are commonly accepted as the norm for the distilled spirit industry.

The traditional goal is to create an enjoyable blend of water, ethanol, and organic compounds known as congeners which are substances other than alcohol or ethanol that are responsible for most of the taste and aroma of distilled alcoholic beverages. Although congeners may include many different substances, some desirable and others not, a key class are esters which are the result of chemical bonding of an alcohol or phenol to an acid, specifically a carboxylic or phenolic acid. Undesirable congeners are dissipated over time through the process of oxidation.

There are quite literally thousands of different esters which may be created, and their development is directed by the types of wood or woods used, and traditionally the nature of the starting raw liquid (is it to be a scotch, bourbon, whisky, rum, other), and the time provided for the aging process.

To some degree the aging process is a blend of myth and science—“if we do this, we will get that.” Essentially, the long duration of the raw liquid resting within the wooden barrel or among saturated wood chips permits polymer chemistry to occur wherein elements of the wood intermix with the raw liquid and over time new compounds, such as esters, are created.

The traditional aging process involving wooden barrels is also subject to loss of eventual product through the natural process of evaporation. Oxidation is an important element of the spirit aging process, and as the wood allows air to enter, it also allows vapors to escape through the sides of the wooden barrel. Often referred to as the Angle Share, the aromatic aroma may well be enjoyed by visitors and employees, but it is the result of an undeniable loss of quantity of the developing aging spirit.

Moreover, long term aging is costly in both space and financial investment to maintain, protect and monitor the developing spirit.

Various parties have explored options to improve the process of making aged distilled spirits. According to U.S. Pat. No. 2,807,547 to Nickol, one known method of producing whisky includes preparing a barrel of white oak wood by charring the interior to an extent and depth established by practice. An aqueous-alcohol distillate (so-called high wine) derived from the fermentation of a cereal mash is introduced into the barrel which is then tightly sealed and held preferably under prescribed conditions of temperature and humidity for a period of years. During this time progressive changes occur, both in the extraction of certain constituents from the charred wood and in the reaction of other constituents originally present in the high wines, either with themselves or with constituents derived from the wood. Broadly speaking, the constituents which characterize the final product, in addition to the base of ethyl alcohol, are organic acids, aldehydes, oil, and organic esters together with coloring matter.

One disadvantage of the aging process, according to U.S. Pat. No. 2,807,547 to Nickol, is that the barrels can only be used once for the production of a satisfactoy grade of whisky which adds substantially to the expense, and the cost of handling liquids in containers or such relatively small size as compared to those used in other industries which handle liquids, is relatively excessive According to U.S. Pat. No. 2,807,547 to Nickol, attempts have been made to dispense with the use or the charred oak barrels by storing the high wines in containers of stainless steel for example, and adding to the high wines so stored an amount of charred oak chips corresponding in ratio to those which would be presented to the high wines in barrel-aging practice, or alternatively to add to the high wines so stored a corresponding amount of the extractives obtained by the aqueous ethyl alcohol extraction of charred wood chips. But, notes U.S. Pat. No. 2,807,547 to Nickol, these attempts have not been successful because, since the whisky is lacking certain essential flavoring constituents when an attempt is made to correct this condition by the use of a larger amount of charred chips or extractives derived therefrom, the resulting whisky is, according to U S. Pat. No. 2,807,547 to Nickol, over-balanced in certain other constituents and is therefore of inferior grade.

U.S. Pat. No. 2,807,547 to Nickol proposes a distillation method via which it is no longer necessary to use wood barrels, and the aging can be carried out in drums of stainless steel or a similar material which can be re-used indefinitely or alternatively can be carried out in large vats or tanks of the same or similar material, with corresponding economies in storage and in transfer.

While U.S. Pat. No. 2,807,547 to Nickol points out the virtues of large scale handling of liquids treated in a distillation process, with such large scale handling including the use of drums or tanks each significantly larger than individual aging barrels, the distilling process still requires heating of the prepared liquid to produce vapor that can subsequently be cooled or condensed into a liquid state. The heating of large volume drums or tanks is often performed via gas-fueled heating elements which heat the drums or tanks themselves to thereby heat the prepared liquid retained in the drum or tank. This indirect heating approach thus leads to less than optimal energy conversion of the heating energy (BTU) of the gas-fuel combustion into thermal heating of the liquid contents of the drums or tanks, as the drums or tanks themselves heat up and do not completely transfer all of their heat content to the liquid contents. Also, the gas-fuel combustion approach can lead to scorching of the liquid contents, wherein some portions of the liquid are subjected to over-heating.

Far more recently, Wen, CN 102433241, has presented a method for fermenting blackberry wine by high-energy pulse microwave aging. Essentially, Wen is setting forth a method of improving the fermentation process by adding dry yeast to clear juice which is then gently fermented at 26-28° C.—the heating achieved by the application of pulsed microwave energy. It will be understood and appreciated that the specific cap to the temperatures is to ensure that yeast killing temperatures are not generated. The use of pulse energy also helps to ensure that there is dissipation of the applied RF energy throughout the clear juice, whereas a continued application would likely result in temperatures well above the desired 26-28° C.

Wen further describes that the aging of the wine is achieved, “Because the impact of the micro-wave energy that the high-frequency electromagnetic field-effect of microwave is produced has caused intensive concussion and friction between each quasi-molecule and molecule in the wine base. Moment has been destroyed all kinds of associated molecule crowds in the wine base. Rapidly part alcohol molecule, organic molecule group, water molecules are cut into individual molecule, be reassembled into relatively stable molecular grouping then, these new molecular groupings have improved the quality of fermented wine in varying degrees just” (translation from original Chinese).

In other words. Wen is clearly teaching the use of micro-wave energy to disrupt the molecules in the clear wine base—e.g., the alcohol molecules, but Wen is also clearly and carefully instructing that the micro-wave energy should not cause issue or harm to the added yeast. Moreover, Wen is using pulsed microwave energy to excite the dipoles of the alcohol or water of the clear wine base.

But as the teachings of Wen are so clearly focused upon the fermentation of clear wine base and some subsequent aging, the absence of wood—indeed the specific teaching of Wen let the juice stand to clarify and then filter to obtain a clear juice which is then the wine base subjected to the pulsed application of microwave energy attenuated to excite the dipoles of the wine, make Wen of no value in the quest for rapid aging of a distilled spirit—a product that while perhaps dependent upon an earlier process of fermentation, is now yeast free and is actually dependent upon the interaction of the distilled spirit with wood for the development of the coveted esters, for “age” and balance.

Hence there is a need for a method and system that is capable of overcoming one or more of the above identified challenges. And it is to innovations related to this subject matter that the claimed invention is generally directed.

### SUMMARY

Our invention solves the problems of the prior art by providing a novel method and system for the rapid aging of a distilled ethyl alcohol, aka a distilled spirit for human consumption, with RF energy.

In particular, and by way of example only, according to one embodiment of the present invention, provided is a method for the rapid aging of distilled ethyl alcohol, including: providing a vessel having at least one aperture suitable for the introduction of radio frequency (RF) energy at a preselected frequency selected to pass through transparent material and be absorbed by opaque material, the vessel having at least one liquid circulating system structured and arranged to circulate liquid from a lower portion of the vessel to an upper portion of the vessel, the at least one aperture coupled to an RF generator structured and arranged to provide the RF energy at the preselected frequency; providing a substantially transparent distilled ethyl alcohol having a first proof; providing at least one unit of wood having a plurality of capillaries containing wood sugar; combining the distilled ethyl alcohol and the at least one unit of wood to provide an opaque mixture, the opaque mixture disposed within the vessel, the opaque mixture having a surface disposed below the at least one aperture; applying by the RF generator through the aperture, a constant RF energy at the preselected frequency, the applied constant RF energy heating the opaque mixture to expand the plurality of capillaries, the heated and expanded capillaries absorbing the alcohol of the distilled ethyl alcohol, the absorbed alcohol dissolving at least the wood sugars into the distilled ethyl alcohol to rapidly age the distilled ethyl alcohol.

In another embodiment, provided is a method for the rapid aging of distilled ethyl alcohol, including: providing a vessel having at least one aperture suitable for the introduction of radio frequency (RF) energy at a preselected frequency into the vessel; providing a distilled ethyl alcohol having a first proof; providing at least one unit of wood having a plurality of capillaries containing wood sugar and resins; combining the distilled ethanol and at least one unit of wood to provide an opaque mixture, the opaque mixture disposed within the vessel, the opaque mixture having a surface disposed below the at least one aperture; and applying a constant RF energy through the aperture at the preselected frequency, the applied constant energy heating the opaque mixture to expand the plurality of capillaries, the heated and expanded capillaries absorbing the alcohol of the distilled ethanol, the absorbed alcohol dissolving at least a portion of the wood sugars and resins into the distilled ethyl alcohol to rapidly age the distilled ethanol.

In yet another embodiment, provided is a system for rapid aging of a distilled ethyl alcohol, including: a vessel having at least one aperture suitable for the introduction of radio frequency (RF) energy at a preselected frequency selected to pass through transparent material and be absorbed by opaque material, the vessel having at least one liquid circulating system structured and arranged to circulate liquid from a lower portion of the vessel to an upper portion of the vessel; an RF generator structured and arranged to provide the predetermined frequency; at least one waveguide disposed between the RF generator and the vessel, the at least one waveguide structured and arranged to convey the generated predetermined frequency from the RF generator to the at least one aperture; and an oxygenator structured and arranged to dispose oxygen within a liquid disposed within the vessel and outgas congeners from the liquid, the vessel further providing at least one vent structured and arranged to vent the outgassed congeners.

### BRIEF DESCRIPTION OF THE DRAWINGS

At least one method and system for the rapid aging of a distilled ethyl alcohol will be described, by way of example in the detailed description below with particular reference to the accompanying drawings in which like numerals refer to like elements, and:

FIG. 1 illustrates a rapid aging system for the aging of a distilled ethyl alcohol with RF energy in accordance with at least one embodiment of the present invention;

FIG. 2 illustrates a cut through view of the vessel shown in FIG. 1 of the rapid aging system, with at least one unit of wood and distilled ethyl alcohol disposed therein as an opaque mixture in accordance with at least one embodiment of the present invention;

FIG. 3 illustrates a cut through view of the vessel shown in FIG. 1 of the rapid aging system, with the initial application of RF energy upon the opaque mixture in accordance with at least one embodiment of the present invention;

FIG. 4 illustrates a cut through view of the vessel shown in FIG. 1 of the rapid aging system, with continued application of the RF energy upon the opaque mixture and the resulting rising column and breakdown of the at least one unit of wood in accordance with at least one embodiment of the present invention;

FIG. 5 illustrates a cut through view of the vessel shown in FIG. 1 of the rapid aging system, with continued application of the RF energy upon the opaque mixture accumulating proximate to the surface of the liquid and the developing absorption of at least dissolved wood sugars by the distilled ethyl alcohol in accordance with at least one embodiment of the present invention;

FIG. 6 illustrates a cut through view of the vessel shown in FIG. 1 of the rapid aging system, with continued application of the RF energy upon the opaque mixture accumulating proximate to the surface of the liquid and the increasing opacity of the ethyl alcohol in accordance with at least one embodiment of the present invention;

FIG. 7 illustrates a cut through view of the vessel shown in FIG. 1 of the rapid aging system, with continued application of the RF energy upon the opaque mixture accumulating proximate to the surface of the liquid and the addition of extra water in accordance with at least one embodiment of the present invention;

FIG. 8 illustrates a cut through view of the vessel shown in FIG. 1 of the rapid aging system following the cessation of application of the RF energy, the opaque mixture being oxygenated and out gassing to provide a finished rapidly aged spirit in accordance with at least one embodiment of the present invention;

FIG. 9 illustrates a high-level flow diagram for a method of rapidly aging a distilled ethyl alcohol in accordance with at least one embodiment of the present invention;

FIG. 10 is a high-level block diagram of a computer system in accordance with at least one embodiment.

### DETAILED DESCRIPTION

Before proceeding with the detailed description, it is to be appreciated that the present teaching is by way of example only, not by limitation. The concepts herein are not limited to use or application with a specific method and system for the rapid aging of a distilled ethyl alcohol with the application of RF energy. Thus, although the instrumentalities described herein are for the convenience of explanation shown and described with respect to exemplary embodiments, it will be understood and appreciated that the principles herein may be applied equally in other types of systems and methods for method and system for the rapid aging of a distilled ethyl alcohol.

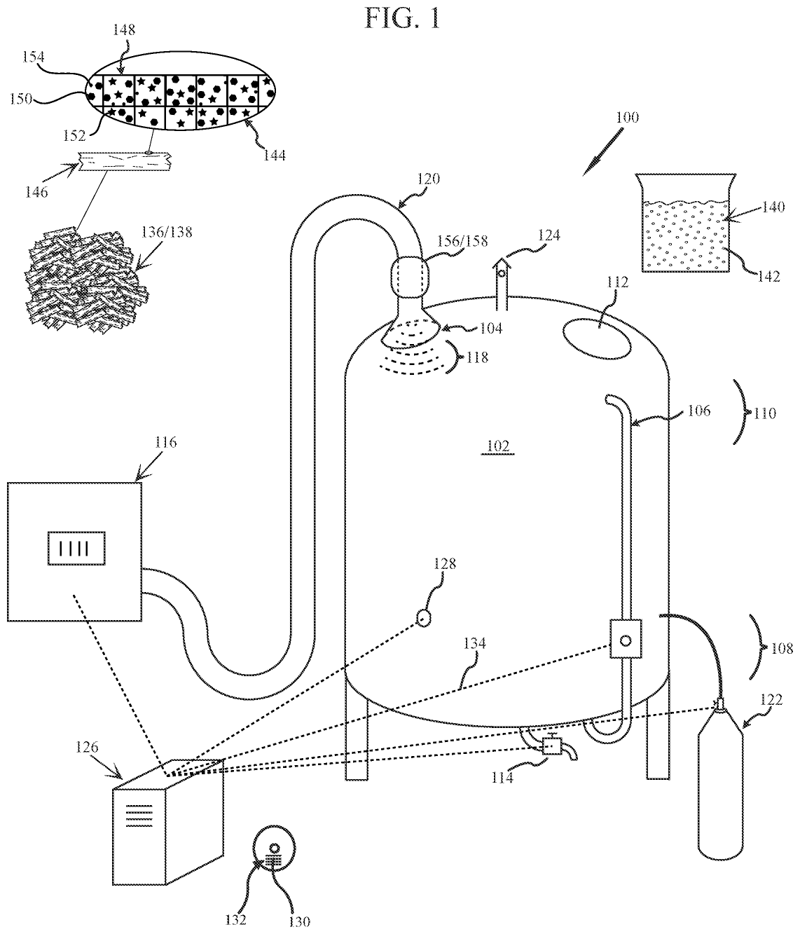

Turning now to the drawings, and more specifically FIG. 1, illustrated is a high-level diagram of a Rapid Aging System 100, herein after RAS 100, in accordance with at least one embodiment of the present invention. It will be understood and appreciated that RAS 100 is a system for the rapid aging of distilled ethyl alcohol—aka, distilled drinking spirits or even just distilled spirits, but not exclusively limited to brandy, bourbon, scotch, gin, tequila, rum, whiskey, and the like with radio frequency (RF) energy.

Moreover, as is conceptually shown in FIG. 1, for at least one embodiment, RAS 100 comprises a vessel 102 having at least one aperture 104 suitable for the introduction of RF energy and at least one circulation system 106 structured and arranged to circulate liquid from a lower portion 108 of the vessel to an upper portion 110 of the vessel.

For at least one embodiment the vessel 102 also provides at least one access hatch 112 through which materials may be disposed into the vessel 102, and at least one drain 114 through which liquid may be extracted from the vessel 102. For at least one embodiment, the drain 114 may be incorporated as a component of the circulation system 106. The drain 114 may also have a pump (not shown) such that the liquid may be pumped from the vessel 102 at a rate greater than that expected from a typical gravity drain.

RAS 100 also includes at least one RF generator 116 structured and arranged to provide RF energy 118 at a predetermined frequency. The provided RF energy 118 is conveyed from the RF generator 116 to the at least one aperture 104 of the vessel 102 by at least one waveguide 120. In addition, for at least one embodiment RAS 100 further includes at least one oxygenator 122, the oxygenator 122 structured and arranged to dispose oxygen within a liquid disposed within the vessel 102 and outgas congeners. The vessel 102 also includes at least one vent 124 for the release of gas from within the vessel 102.

For at least one embodiment, the vessel is formed of stainless steel. The vessel may also be equipped with one or more liquid valve ports (not shown) such that liquid may be disposed within the vessel 102 without the use of the access hatch.

For at least one embodiment, the RAS 100 further includes at least one computer 126 that has been structured and arranged to control the RF generator 116, the circulation system 106, the oxygenator 122, and optionally the drain 114. In addition, the at least one computer 126 may further have communication with one or more sensors 128, affixed to or disposed within the vessel. In varying embodiments, these one or more sensors 128 may be structured and arranged to sense various factors, such as temperature at one or more locations within the vessel 102, fluid level, opacity of the fluid, rate of liquid circulatory flow, the nature of gasses within the vessel, and such other data points as may be desired in varying embodiments.

In varying embodiments, the at least one computer 126 may indeed be a single integrated computing system structured and arranged for the control and operation of RAS 100. For yet other embodiments, the control and operation of RAS 100 may be subdivided to different physical computer systems 126, which are operated in consort for the control and operation of RAS 100. For either situation, the one or more computer systems may be either off the shelf computing systems or custom-built systems that are further adapted by hardware or software 130 as provided by physical media 132 for the control and operation of RAS 100.

It will be understood and appreciated that the one or more computers 102 have wired (network cables or other direct wire(s)) or wireless (Wi-Fi, Bluetooth, Cellular, etc. . . . ) communication links 134 with one or more elements of RAS 100, and whether wired or wireless, such communication channels may intermittent or constant without departing from the scope of the present invention.

As will be understood in greater detail with respect to the following narrative description and accompanying illustrations, RAS 100 is structured and arranged to permit the rapid aging of a distilled spirit, such as distilled ethyl alcohol. It will be understood and appreciated, that such rapid aging is based in part upon the forced and accelerated interaction between wood and the distilled ethyl alcohol.

Moreover, distillation of a spirit is understood and appreciated to be the process and/or method of taking a fermented ethanol—such as may be derived from the fermentation of grain(s), grape(s), or berry(s), fruits, plants etc. . . . The resulting fermented aqueous mixture is then heated to separate the ethanol from the water as the ethanol has a lower evaporation point and therefore may be easily separated from the water to provide a highly concentrated alcoholic liquid, e.g., the ethyl alcohol. Often there are other specific elements such as aldehydes, esters and fatty acids that are also present with the resulting ethyl alcohol solution, all of which have specific flavors and aromas, the unique combinations of these chemicals making each type of eventual spirit different from one another.

As noted above, in this initial state, most such distilled ethyl alcohol liquids are not typically consumed as a desirable flavor, nose, and color profiles have not yet been established and matured. These desirable flavor, nose, and color profiles are traditionally provided by wood of various types in which the distilled ethyl alcohol is aged for a period typically measured in months and years, if not decades to permit a natural interaction between the distilled alcohol and wood material.

To achieve this rapid aging, RAS 100 is provided with one or more units of wood 136 and distilled ethyl alcohol 140, which is appreciated to be substantially transparent. For purposes of discussion and illustration, the initially substantially transparent nature of the distilled ethyl alcohol 140 is conceptually illustrated by dotted circles 142. The distilled ethyl alcohol 140 has a first proof of alcohol. Alcohol proof is understood and appreciated to be the measure of ethanol (alcohol) content in an alcoholic beverage, and is generally understood and appreciated to be 1.821 times the percentage of alcohol by volume. For at least one embodiment the first proof of the distilled ethyl alcohol 140 is about one hundred twenty-five proof (125 proof).

It will be further understood and appreciated that for at least one embodiment, the one or more units of wood 136, are provided as wood chips 138. Further, the wood chips 138 are provided by toasting wood chunks, such as wood staves, in an oven and then chipping the toasted wood into chips.

For at least one embodiment, the use of small wood chips 138 is desired so as to permit rapid saturation of the wood by the distilled ethyl alcohol 140. For at least one embodiment the chips are about ½″ (0.5 inch) in size.

It will be understood and appreciated, that as shown in the enlarged oval 144 as taken from enlarged wood chip 146, wood, like most green plants, is a cellular structure presenting a plurality of cells or capillaries 148 which are typically established by cellulose and hemicellulose, two common polysaccharides that serve as the structural components of plant cell walls. As polysaccharides, cellulose and hemicellulose are appreciated to comprise a number of sugar molecules.

It will also be understood and appreciated that the wood presents various concentrations of cellulose, resins, tannins, and other materials. The chemical composition of such materials—cellulose, hemicellulose, resins, tannins, etc. . . . may contain similar molecules in different proportions.

For purposes of the present invention, and the following description, the nature of these materials—e.g., the cellulose, hemicellulose, resins, tannins, etc. . . . may be simplified, such that the capillaries 148 cellulose, hemicellulose, resins, tannins, etc. . . . of the wood chips 138 are appreciated to provide wood sugars 150 (conceptually shown as hexagons) and resins 152 (conceptually shown as stars), and other materials such as, but not limited to gums or tannins, shown as dots 154. For ease of illustration and discussion, these wood sugars 150, resins 152 and other materials 154 have been illustrated as separate elements distinct from the capillaries 148 themselves.

It is further appreciated that the types of wood sugars 150, resins 150 and other materials 154 vary by wood species—white oak, aka American oak, French Oak, Ash, Cherry, Maple, Walnut, etc. . . . . Even within a given type of wood, the nature of the grain—course, medium, fine, superfine—present different options for the nature of the capillaries 148 and thus the concentrations of wood sugars 150, resins 152 and other materials 154 vary as well. And further, end grain and surface grain present different orientations of the capillaries 148, and as such permit different access to the wood sugars 150, resins 152 and other materials 154. Indeed, within the distilled beverage industry it is generally accepted that end grain wood provides more tart/bitter tasting notes, while surface grain provides smooth/flavorful notes. Indeed, the orientation of the grain in traditional barrel aging is known to provide different resulting flavor characteristics. Of course, as barrels are made from strips of wood, it is generally more costly to establish strips of wood with the grain running perpendicular to the longitudinal center of the barrel—but such may be provided in the interest of specific flavor profiles.

Chipping the at least one unit of wood 136 provides an appreciable mix of surface grain and end grain that may not be easily obtainable with traditional barrel aging. Indeed, alterations to the process of chipping may permit the wood chips 138 to be provided with more surface grain relative to end grain, more end grain relative to surface grain, or about an even approximation of surface grain to end grain. Such fungibility in how the wood chips may be provided advantageously provides a wide spectrum for the eventual characteristics of the rapidly aged distilled ethyl alcohol 140 provided by RAS 100.

It is the forced and accelerated interaction of the distilled ethyl alcohol 140 with the wood chips 138, and more specifically these wood sugars 150, resins 152 and other materials 154, achieved through the constant application of RF energy at a preselected frequency which advantageously permits RAS 100 to rapidly age the distilled ethyl alcohol 140 in a matter of hours to the equivalent of many years of traditional barrel aging. Indeed, for at least one embodiment, RAS 100 rapid ages the distilled ethyl alcohol 140 in about twenty-four (24) hours to the equivalent of about ten (10) years of traditional barrel aging.

More specifically, RAS 100 is structured and arranged to apply constant RF energy as a preselected frequency to heat and break down the capillaries 148 of the wood chips 138 thereby advantageously permitting the alcohol of the distilled ethyl alcohol 140 to dissolve and release at least the wood sugars 150 from the wood chips 138 into the distilled ethyl alcohol 140.

As RAS 100 is structured and arranged to generate heat, and as noted above in the brief discussion of distillation alcohol has a low evaporation point, it is most probable that the rapid aging process achieved by RAS 100 may result in evaporative liquid vapors. These vapors could be detrimental to the RF generator 116, and as with the loss of the “angles share” in traditional barrel aging represent a potential loss of eventual product. As such, at least one embodiment of RAS 100 incorporates a vapor recovery system 156. For at least one embodiment, the vapor recovery system 156 is a heat exchanger 158. This heat exchanger may be incorporated with or coupled to a portion of the waveguide 120 to capture, condense and return liquid back to the vessel.

To appreciate this advantageous achievement, it is helpful to review that radiation is emission of energy from a source and can exist across a spectrum from very low-energy (low frequency), such as power lines, to very high-energy (high frequency), such as X-rays and gamma rays. Radio frequency energy, commonly referred to as RF energy, includes radio waves and micro waves and is found at the lower-energy end of the electromagnet spectrum, below visible light. When absorbed in large amounts by materials, RF energy can produce heat.

In vastly simplified terms, all matter is comprised of atoms with electrons, and how these atoms are arranged with one another defines the nature of the material and is why one material is different from another. In these various arrangement configurations, the electrons are appreciated to be at different, but specific energy levels.

As RF energy attempts to transverse through a material, the ability to do so is determined by whether the frequency of the RF energy interacts with the electrons at their specific energy levels. Solid materials absorb the energy, while transparent materials do not. It will also be understood and appreciated that a material may be “solid” with respect to one frequency of RF energy, while “transparent” to another.

Further, when a material appears solid to an RF frequency, increasing the RF energy frequency intensifies the interaction of the RF energy upon the skin or surface of the material, commonly referred to as surface effect. In contrast, decreasing the RF energy frequency can and will permit the applied RF energy to react with the surface and underlying substance of the material. Indeed, careful selection of a predetermined frequency of RF energy permits substantially uniform absorption of the RF energy throughout a given unit of material.

Again, in vastly simplified terms, RF energy heating is the result of the absorbed RF energy agitating the molecules of an RF energy absorbing material to create friction between the molecules. More specifically, RF energy is composed of perpendicular oscillating electric and magnetic fields, i.e., electromagnetic fields. Molecules may be viewed as tiny electrical systems and as such, any given material has an electric dipole due to the distribution of the positive and negative charge of the various atoms bonded together to provide the molecule. An electric dipole may be influenced to align in one direction or another based on the presence and orientation of a corresponding electromagnetic fields.

For a material that is “solid” to a specific RF frequency, when a sufficient amount of the RF energy is applied such that the oscillating electromagnetic fields of RF energy induce oscillation of the molecules comprising the material by aligning the dipole fields of the molecules, the resulting friction between the oscillating molecules results in heat.

Moreover, by selecting different frequencies, RF energy can be directed to impinge upon just a surface causing localized surface heating, or to penetrate the surface so as to cause a more uniform heating throughout the material. In addition, the frequency of the RF energy can be selected to pass through substantially transparent materials—air, gas, glass, transparent liquid such as distilled ethyl alcohol 140, etc. . . . —while being absorbed by non-transparent, i.e., opaque, materials, such as wood chips 138.

When RF energy is applied in pulses, generally each pulse is absorbed and partially dissipates within the material before the next pulse is applied. Pulse RF energy application is therefore often appropriate where even dissipation of the applied energy is desired throughout a large volume of material and/or localized areas of high temperature are not desired and/or may be detrimental to an overall environment requiring uniform temperature or at least temperatures that do not exceed thresholds that would degrade portions of the environment.

Conversely, constant application of RF energy is far more appropriate when and where intense localized heating is fundamentally necessary and dissipation of the applied RF energy throughout the environment is detrimental to the intended purpose of localized heating. Of course, rapid pulsing may in some embodiments be nearly as efficient as constant energy, and/or may be desired for one or more reasons.

With respect to the present invention, RAS 100, and more specifically the RF generator 116, is structured and arranged to provide constant RF energy 118 at a preselected frequency, selected to pass through substantially transparent material, such as the distilled ethyl alcohol 140 in its initial substantially transparent form, while being absorbed by opaque material, such as the wood chips 138. Applied as constant RF energy at the preselected frequency, the RF energy absorbed by the wood chips 138 results in rapid heating of the wood chips 138, and breakdown/degradation/decomposition of the wood chips 138, and more specifically the capillaries 148 therein, thus permitting the release and absorption of at least the wood sugars 150, and potentially resins 152 and other materials 154 by the distilled ethyl alcohol 140.

Moreover, for at least one embodiment, the predetermined frequency of constant RF energy 118 is selected to pass through the distilled ethyl alcohol 140 for application to the at least one unit of wood 136. Stated differently, for at least one embodiment the predetermined frequency of constant RF energy is selected in a range to impinge upon opaque material within the vessel more than dipoles of the alcohol or water. More specifically, for at least one embodiment, the predetermined frequency of constant RF energy 118 provided by the RF generator 116 is in the range from about 3 MHz to about 915 MHz.

It may thus be appreciated that the constant RF energy as generated and applied by RAS 100 is not traditional microwave energy. The generated constant RF energy as utilized by RAS 100 is both at a lower frequency (megahertz rather than gigahertz) and is not intended to specifically interact with the diploes of water or alcohol molecules.

For embodiments incorporating at least one computer 126 as noted above, the predetermined frequency of constant RF energy may be adjusted during the rapid aging process as advantageously permitted by RAS 100.

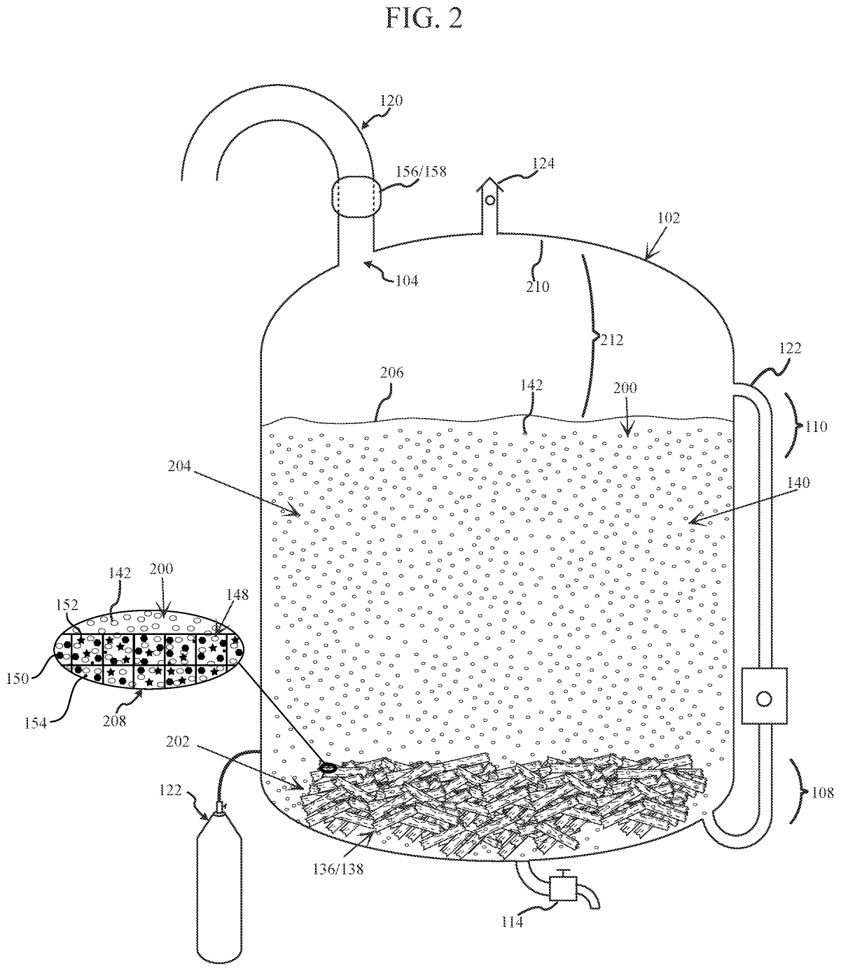

The process for rapid aging of a distilled ethyl alcohol 140 may be more fully appreciated with respect to FIGS. 2-8, wherein an exemplary vessel 102 has been enlarged and shown in cut-through view for ease of illustration and discussion of at least one method for rapid aging of distilled ethyl alcohol 140 as advantageously permitted by an embodiment of RAS 100.

As shown in FIG. 2, at least one unit of wood 136, and more specifically wood chips 138 have been provided, as has a substantially transparent distilled ethyl alcohol 140, the initial transparency of the distilled ethyl alcohol 140 again conceptually illustrated by dotted circles 142. Combined, the wood chips 136 and distilled ethyl alcohol 140 provide an opaque mixture 200, which is disposed within the vessel 102.

It will be appreciated that the opaque mixture 200 need not be uniformly opaque. Indeed, initially as the wood chips 138 saturated by the distilled ethyl alcohol 140 are at the lower portion 108 of the vessel 102, it will be appreciated that the opaque portion 202 of the opaque mixture 200 is substantially coincident with the location of the wood chips 138. A substantially transparent portion 204 of the opaque mixture 200 is shown above the opaque portion 202.

As shown in the enlarged oval 208 presenting an enlarged portion of a wood chip 138, the capillaries 148 of the wood chip 138 are substantially intact, and present a plurality of wood sugars 150, resins 152, and other materials 154. It may also be appreciated that distilled ethyl alcohol 140, as indicated by the dotted circles 142 has saturated into the capillaries 148 of the wood chips 138.

Alcohol is a solvent to wood sugars and may also be a solvent to some wood resins. Accordingly, for at least one embodiment, the efficiency and effectiveness of the RAS 100 to rapidly age the distilled ethyl alcohol 140 is improved by permitting the wood chips 138 to become fully saturated before the application of constant RF energy.

For at least one embodiment, the opaque mixture 200 of distilled ethyl alcohol 140 and wood chips 138 may be created ahead of time and set aside in another container where it is left to saturate for a period of time before being disposed within the vessel 102. Alternatively, the opaque mixture 200 may be established within the vessel 102 and left to saturate before the application of constant RF energy is commenced. For at least one embodiment, the opaque mixture 200 is allowed to rest for about 24 hours to saturate the at least one unit of wood 136, aka the wood chips 138, prior to the application of the constant RF energy.

For the opaque mixture 200 as disposed within the vessel 102, for at least one embodiment, the ratio of the distilled ethyl alcohol 140 to the at least one unit of wood 136, aka wood chips 138, el is between about 2.4 oz to 4.1 oz of wood per gallon.

It may also be appreciated from FIG. 2, that the opaque mixture 200 has a surface 206 that is disposed below the inner top 210 of the vessel. Moreover, for at least one embodiment there is an air gap 212 within the vessel between the surface 206 and the inner top 210 of the vessel 102, and this air gap 212 is in fluid communication with the vent 124.

As shown, for at least one embodiment, the aperture 104 for RF energy is also disposed in the vessel 102 proximate to the inner top 210. Such placement of the aperture 104 configures the aperture 104 to thus be above the surface 206 of the opaque mixture 200. Although this configuration may be desired in some embodiments, as it permits the process of circulation to refresh the quantity of opaque mixture 200 directly below the aperture 104, in varying embodiments the location of the aperture 104 for the introduction of RF energy to the opaque mixture 200 may be disposed in other locations of the vessel 102 without departing from the scope of the present invention. Moreover, as the following description will explain, the RF energy is provided into/upon dense portions of the opaque mixture 200. Any placement of the aperture for RF deliver that achieves application of RF energy upon dense portions of the opaque mixture 200 is certainly in keeping with the teachings herein. For ease of illustration, discussion, and fabrication, for at least one embodiment the aperture 104 is shown disposed proximate to the top of the vessel 102 such that it is above the surface 206 of the opaque mixture 200.

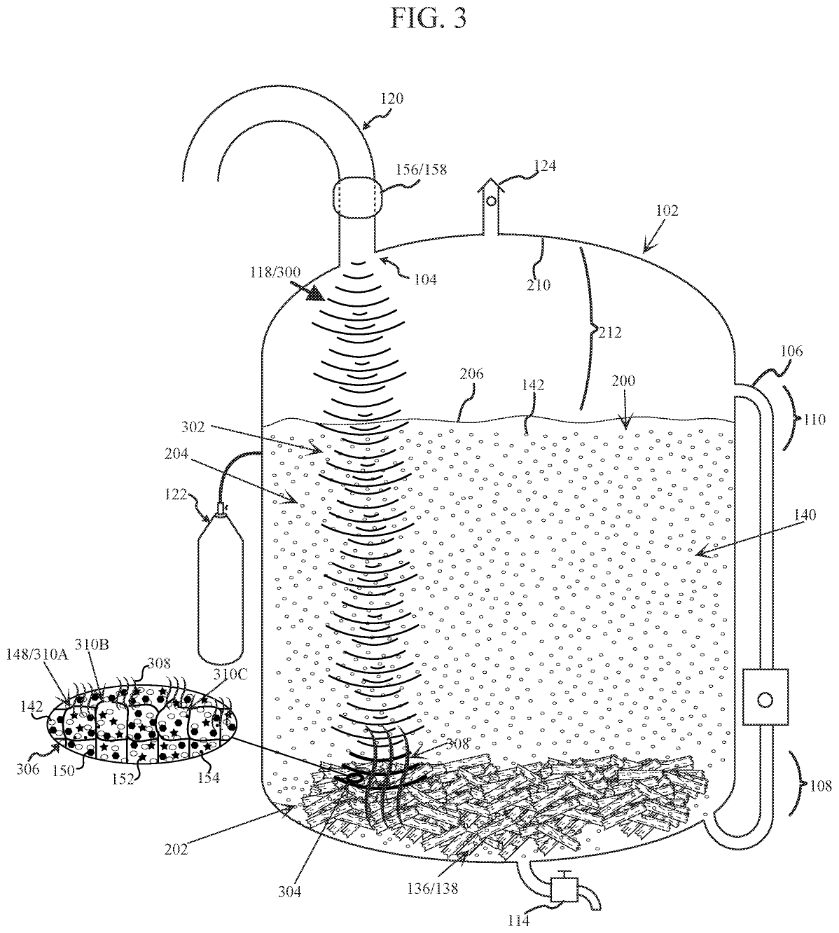

In FIG. 3, the RF generator (see FIG. 1) has been engaged and constant RF energy 300 is being directed from the waveguide 120 through the aperture 104 and into the vessel 102. As is conceptually illustrated by thin lines 302 versus thick lines 304 used to illustrate the constant RF energy 300, the constant RF energy is passing through the transparent portion 204 of the opaque mixture 200 (the distilled ethyl alcohol 140) and is impacting the opaque portion 202 of the opaque mixture 200, specifically the wood chips 138.

As may be appreciated from the brief overview above, the constant RF energy 300 impinging upon the opaque mixture 200, and most specifically the wood chips 138, is applied with a frequency and intensity sufficient for the generation of heat within the wood chips 138. Moreover, the constant RF energy 300 generates a region of high temperature proximate to the opaque elements of the opaque mixture. For the exemplary early stage of the rapid aging process as shown in FIG. 3, it may be understood and appreciated that at this point in the process the opaque elements are substantially the wood chips 138.

For at least one embodiment, the heat generated proximate to, and/or within, the opaque elements of the opaque mixture 200 is greater than about sixty degrees Celsius (60° C.). For at least one embodiment, the heat generated proximate to, and/or within, the opaque elements of the opaque mixture 200 is about sixty-five point five degrees Celsius (65.5° C.).

As may be appreciated from enlarged oval 306 presenting an enlarged portion of a wood chip 138, the constant RF energy as applied to the wood chip 138 is resulting in the generation of heat 308 (shown as wavy lines) within the wood chip 138. This resulting heat induces expansion of the wood chip 138, and more specifically expansion and distortion of the capillaries 148/310. As has been conceptually shown, capillary 310A is distorted and capillaries 310B and 310C have ruptured.

This heat induced expansion and distortion of the capillaries 148/310 permits the capillaries 148/310 to more readily absorb the alcohol of the distilled ethyl alcohol 140. And, as alcohol is a solvent to sugars, the absorbed alcohol loosens and dissolves at least the wood sugars 150 into the distilled ethyl alcohol 140. The expanded condition of the capillaries 148/310 also permits the distilled ethyl alcohol 140 with loosened and/or dissolved wood sugars 150, resins 152 and other materials 154 to flow away from the at least one unit of wood 136/wood chip 138.

Convection is movement caused within a fluid by the tendency of hotter materials, which are therefore less dense, to rise while colder, and therefore denser, materials sink under the force of gravity.

The concentrated heating of the wood chips 138 also results in heating of the distilled ethyl alcohol 140 that is proximate to and/or within the heated wood chips 138, as well as the heating of the wood sugars 150, resins 152 and other materials 154 that may have been dissolved into, or dislodged by, the distilled ethyl alcohol 140.

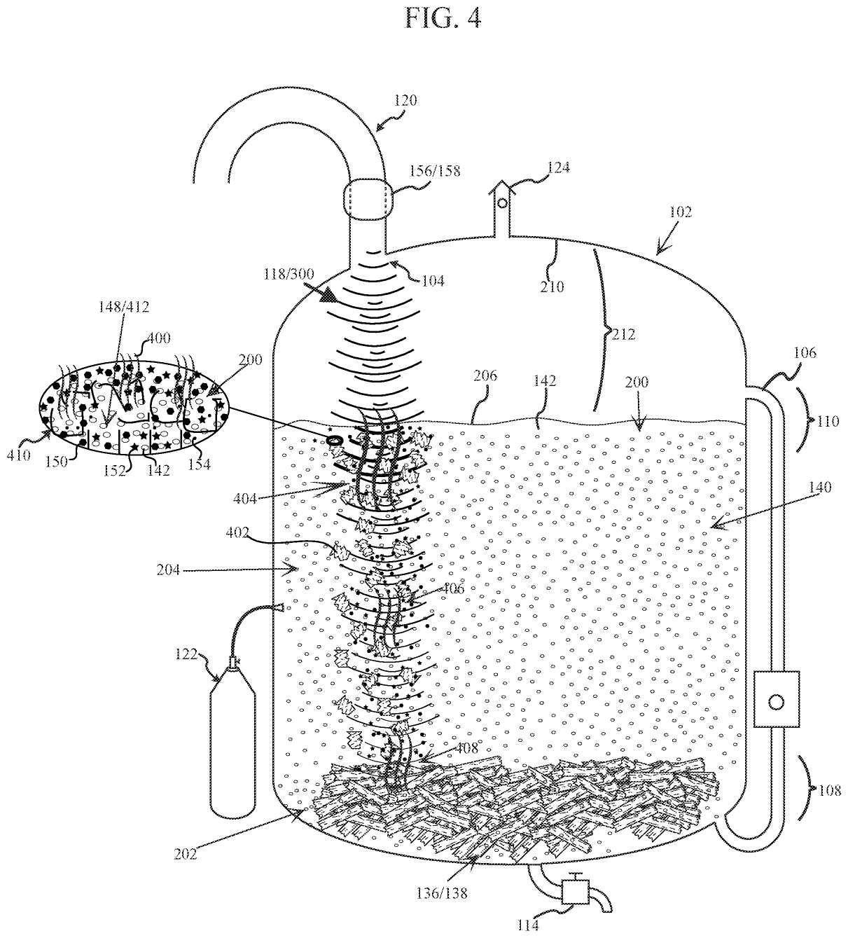

In keeping with the conventions of convection these heated materials being less dense, will rise in the vessel 102 as is shown in FIG. 4. Indeed, within the column of rising heated material 400 may be entire wood chips 138 or at least pieces 402 thereof.

As may also be appreciated from FIG. 4, this column of rising heated material 400 presents a rising column of opaque elements, such that the constant RF energy 300 is interacting with opaque material along the rising column, with the most intense interaction and heat 404 now occurring proximate to the surface 206. As shown, the constant RF energy 300 is still penetrating to the wood chips 138 in the lower portion of the vessel 102, and heat 406 and 408 is being generated along the entire column.

As is shown from enlarged oval 410, the capillaries 148/412 are now even further expanding, and/or degrading such that even more wood sugars 150, resins 152 and other materials 154 are interacting with the distilled ethyl alcohol 140, and freely flowing away from the wood chips 138 for dissipation throughout the opaque mixture 200. The opaque mixture 200 is still somewhat separated into an opaque portion 202 and a transparent portion 204, but thermally driven mixing is occurring.

For the purposes of discussion and demonstration through illustration, in FIGS. 2, 3 and 4, the circulation system 106 has been shown as off—such that no powered circulation is occurring within the vessel 102. For at least one embodiment, the circulation system 106 is engaged at essentially the same time as the constant RF energy 300 is applied.

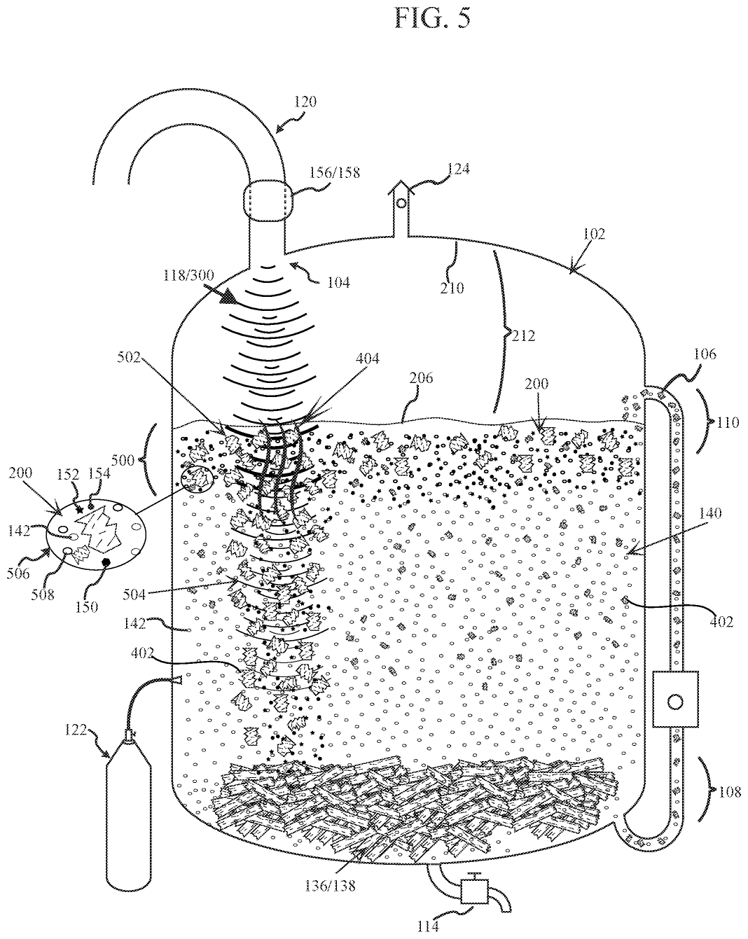

In FIG. 5 the circulation system 106 has been engaged such that liquid from the lower portion 108 of the vessel 102 is circulated to the upper portion 110 of the vessel 102. For at least one embodiment, the circulation system 106 is structured and arranged so as to be accommodating to the wood chips 138 or pieces 402 thereof. As such, the concentration of opaque material 500 adjacent to the surface 206 is increased from that of the initial resting state shown in FIG. 2.

As the distilled ethyl alcohol 140 is indeed a liquid with a high concentration of alcohol, and alcohol has a lower evaporation point than water, the intentional heating of the wood chips 138 and resulting heating of the proximate distilled ethyl alcohol 140 could result in unintentionally evaporating away some of the alcohol. By circulating the opaque mixture 200 the intense and concentrated heat may be applied to the opaque materials to facilitate the release of the wood sugars 150, resins 152 and other materials 154, but the circulation of the liquid opaque mixture 200 as a whole helps to minimize the evaporative loss and somewhat cools the liquid most proximate to the sites of constant RF energy 300 impingement.

In addition, the constant circulation continually refreshes the surface 206 as the constant RF energy 300 is applied, thereby ensuring that the opaque elements of the opaque mixture 200 proximate to the surface 206 receive high concentration of the predetermined frequency of the constant RF energy 300.

As may be appreciated in FIG. 5, the high concentration of opaque materials 500 present in the opaque mixture 200 proximate to the surface 206 results in the majority of the constant RF energy 300 interaction occurs proximate to the surface, with less RF energy being received by the materials below. This has been conceptually illustrated with the use of thick lines 502 in the constant RF energy 300 within the opaque materials 500 proximate to the surface 206, with lighter lines 504 in the constant RF energy 300 in the column of material shown there below.

This permits the opaque materials proximate to the surface to be hotter while the materials at the bottom are cooler. In other words, the opaque mixture 200 proximate to the surface 206 is hotter than the opaque mixture 200 proximate to the bottom of the vessel 102. It will also be appreciated that as the opaque mixture 200 is circulated, the opacity is beginning to even out throughout the mixture. It will also be appreciated in enlarged oval 506 that some of the dotted circles 142 representing substantially transparent distilled ethyl alcohol 140 are now appearing as solid circles 508 to conceptually indicate that the distilled ethyl alcohol 140 itself is becoming somewhat opaque, though still translucent.

Moreover, circulation of the opaque mixture 200 advantageously permits a degree of overall temperature control upon the opaque mixture 200. Indeed, where the operation of RAS 100 is at least in part directed by the at least one computer 126 (see FIG. 1), the control of the RF generator 116 (see again FIG. 1) and the circulation system 106 may provide even greater overall regulation of the overall temperature of the opaque mixture 200.

For at least one embodiment, the aperture 104 may be fitted with a glass or other material transparent to the constant RF energy. For yet another embodiment, the aperture 104 may be physically open such that rising fumes and gasses from the heated opaque mixture may actually enter at least a portion of the waveguide 120. In at least one such embodiment, the waveguide 120 may be fitted with a heat exchanger 158 structured and arranged to cool the rising vapors such that they are condensed back into liquid and returned to the opaque mixture 200.

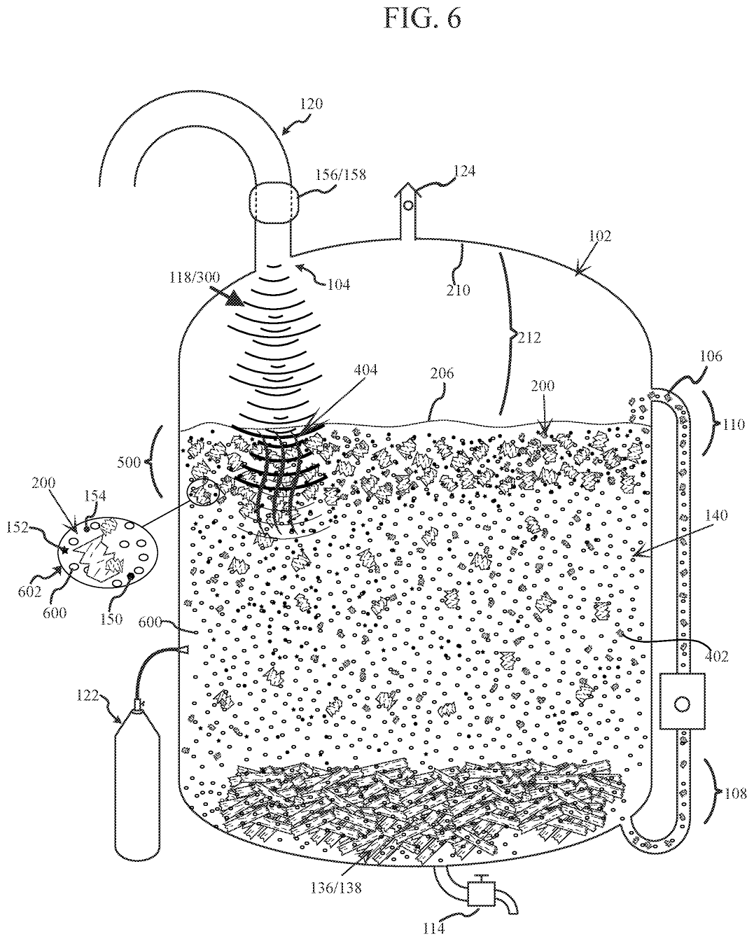

In FIG. 6, the rapid aging process of RAS 100 has progressed, and circulation has aided in further distributing opaque materials throughout the opaque mixture 200. Indeed, as the wood sugars 150, resins 152 and other materials 154 have been released from the wood into the distilled ethyl alcohol 140, and at least some of these elements being dissolved therein, the opacity of the opaque mixture 200 as a whole is increasing. The dotted circles 142 (not shown in FIG. 6) indicating the initial transparency of the distilled ethyl alcohol 140 in prior drawings are now replaced by solid circles 600 indicating an overall darkening of the liquid, see enlarged oval 602.

As wood sugars 150 and resins 152 are dissolved into the distilled ethyl alcohol 140 carboxylic acids are formed, which in turn react with the distilled ethyl alcohol 140 to form esters through a process known as esterification. This is a process that traditionally occurs very slowly and gradually over long periods of time in traditional barrel aging.

However, the RAS 100 and more specifically the precise application of constant RF energy 300 at a preselected frequency advantageously permits rapid development of esterification. Still, it will be understood and appreciated that the applied constant RF energy 300 is not acting upon the alcohol or water molecules specifically, but the heated and released wood sugars 150, resins 152 and other materials 154 for the creation of compounds (esters) as the result of accelerated polymer chemistry.

As noted above, for at least one embodiment the first proof of the distilled ethyl alcohol 140 is about 125 proof. At this proof, the concentration of alcohol in the distilled ethyl alcohol is highly effective as a solvent advantageously permitting the rapid and nearly complete release of at least the wood sugars 150 from the capillaries 148 (not shown in FIG. 6). However, these released wood sugars 150 are still complex compounds, phenolic compounds specifically.

For the desired flavor, color and characteristics of an aged spirit, it is essential that these complex compounds be further broken down and dispersed. The addition of water aids in this process because water permits the complex compounds (the Phenolic compounds) to oxidize—which the initial higher proof of alcohol does not.

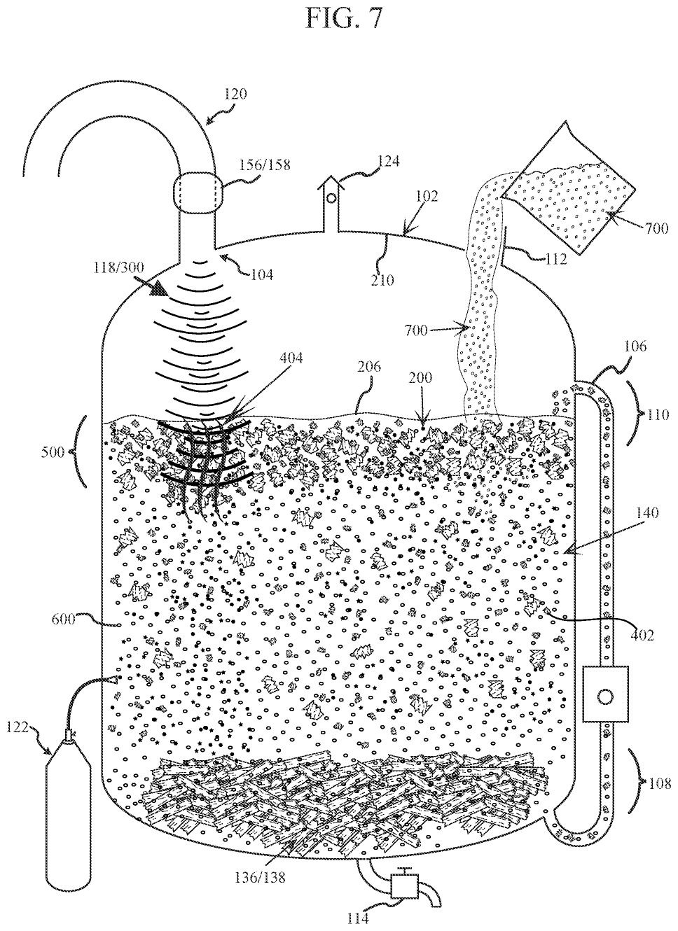

As such, for at least one embodiment as is shown in FIG. 7, after the rapid aging process of RAS 100 has been performed for a period of time to sufficiently achieve the release of most of the wood sugars 150, resins 152 and other materials 154, a quantity of water 700 is added to the opaque mixture 200 within the vessel 102. For at least one embodiment the addition of water 700 may be achieved pouring the water through hatch 112.

The addition of this water 700 results in a second proof of the opaque mixture that is lower than the first proof of the initial distilled ethyl alcohol 140. This lower proof with the newly added water allows the complex compounds (the Phenolic compounds) to oxidize more completely than is possible when the opaque mixture 200 is kept at the first proof. For at least one embodiment this second lower proof is about one hundred thirteen proof (113 Proof).

Moreover, for at least one embodiment seeking to provide a high quality rapidly aged spirit such as, but not limited to, bourbon or whiskey as the result of the rapid aging of the distilled ethyl alcohol 140, it is the combination of having a high first proof for the solvent assisted release of at least the wood sugars 150 in combination with the subsequent addition of water to achieve a second lower proof that achieves the desired result. Starting with a lower first proof does not result in as efficient and complete a release of the wood sugars 150, and omitting the additional water to drop to the second proof more favorable to oxidation does not result in the same level of quality in the resulting rapidly aged distilled ethyl alcohol 140.

As noted above, the creation of an aged spirit deemed enjoyable by master tasters in the beverage arts, typically includes the development of congeners which are the substances other than alcohol or ethanol that are responsible for most of the taste and aroma of the distilled alcoholic beverage. Under this same label of “congeners” are also undesirable compounds such as butane, methanol, hydarzines, acetates and acetadldeyhes.

Fortunately, while good and desirable congeners are fairly stable and may actually improve with oxidation, the undesirable congeners tend to outgas from the liquid as a result of oxidation. As such, and to foster the development of even more esters as are the result of chemical bonding of an alcohol or phenol to an acid, specifically a catholic or phenolic acid, for at least one embodiment, RAS 100 includes an oxygenator 122.

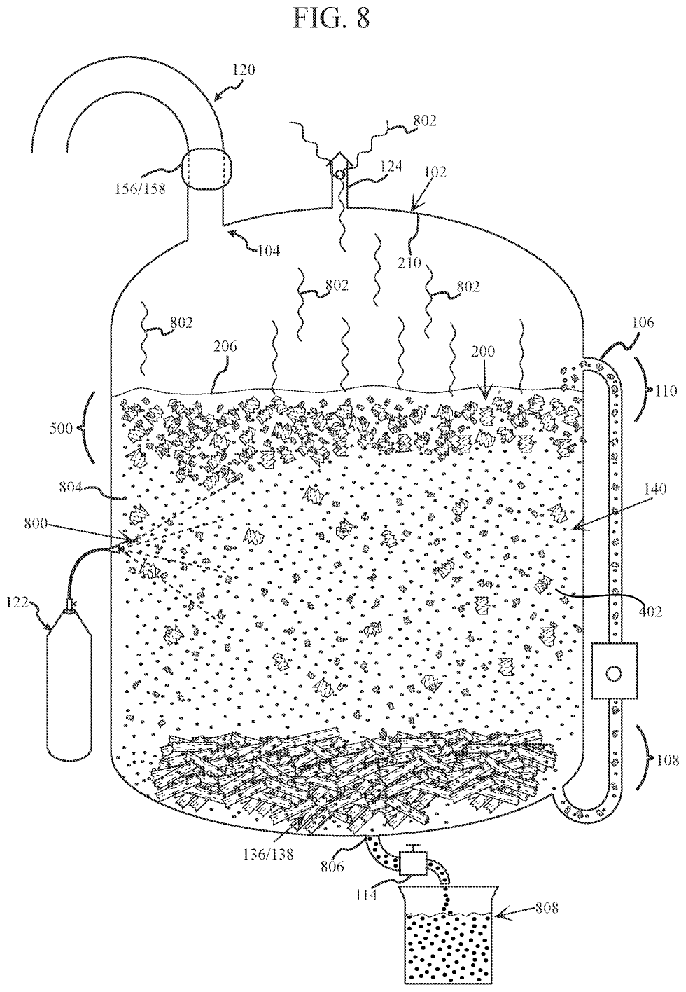

Some congeners are desirable while others represent undesirable elements. As shown in FIG. 8, while the opaque mixture 200 is still very warm, such as about 43.3 degrees Celsius, for at least one embodiment, oxygen 800 is provided into the opaque mixture 200 from the oxygenator 122. Although shown for ease of illustration and discussion to be injected from the side, the oxygen 800 may be introduced through a bubbler stone, ring, jet or combination thereof and from one location or a plurality of locations within the vessel 102.

As circulation of the opaque mixture 200 is continued during the oxygenation process, the congeners and other volatiles resulting within the opaque mixture 200 from the rapid aging process as described above are provided ample opportunity to react with the introduced oxygen with the result of off gasses 802 being released and vented from the vessel 102. For at least one embodiment, one or more sensors may be disposed within the vent to detect and measure the presence or absence of gasses and/or gaseous substances for the determination of when the off-gassing process has been substantially concluded.

With the process of rapid aging of the distilled ethyl alcohol 140 essentially concluded, the solid circles 508 have now transitioned to solid dots 804 to conceptually illustrate that the distilled ethyl alcohol 140 is now itself uniformly opaque. The opaque mixture 200 is extracted from the vessel 102, such as through a drain 114. To provide the expected essentially clear but colored aged spirit, the extracted opaque mixture 200 is filtered through at least one filter 806 to remove wood and other particle residue.

The resulting filtered rapidly aged ethyl alcohol 808 is now ready for bottling, distribution and consumption.

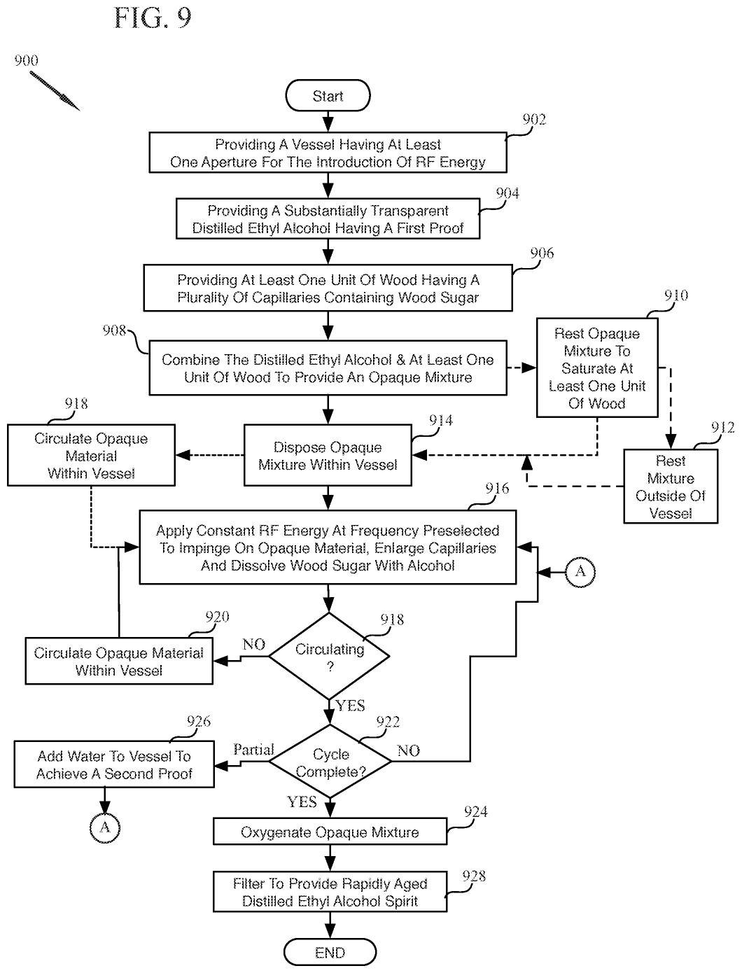

With respect to the above-described processes of rapidly aging a distilled ethyl alcohol 140, FIG. 9 presents a high-level flow diagram illustrating at least one method 900 according to an embodiment of rapidly aging a distilled ethyl alcohol 140. It will be understood and appreciated that the described method 900 need not be performed in the order in which it is herein presented, but that this is merely exemplary of one method of rapid aging of distilled ethyl alcohol 140, such as may be achieved with at least one embodiment of RAS 100.

FIG. 9 conceptually illustrates a high-level flow diagram depicting at least one method 900 for rapidly aging a distilled ethyl alcohol 140, which may be further understood and appreciated with respect to FIGS. 2-8 Moreover, method 900 generally begins with providing a vessel 102 having at least one aperture 104 for the introduction of RF energy into the vessel, block 902.

It will be understood and appreciated that the vessel 102 may be substantially as described above, the aperture 104 connected by a waveguide 120 to an RF generator 116 structured and arranged to provide constant RF energy at a predetermined frequency.

Method 900 continues with the providing of a substantially transparent distilled ethyl alcohol 140 having a first proof, block 904 (see FIG. 1). Additionally, at least one unit of wood 136 (see FIG. 1) having a plurality of capillaries containing wood sugar is provided, block 906.

The at least one unit of wood 136 and distilled ethyl alcohol 140 are combined to provide an opaque mixture 200 (see FIG. 2), block 908. For at least one optional embodiment, the opaque mixture 200 is rested to fully saturate the at least one unit of wood 136 with the distilled ethyl alcohol 140, optional block 910. As an additional option, this combination and resting of the opaque mixture may occur outside of the vessel 102, optional block 912.

Ultimately, the opaque mixture 200 is disposed within the vessel 102, block 914. With the opaque mixture 200 so disposed within the vessel 102, a constant RF energy at a frequency preselected to impinge on the opaque material is applied, block 916. This applied constant RF energy results in heat within the opaque material which enlarges the capillaries of the at least one unit of wood 138 and permits the alcohol of the distilled ethyl alcohol 140 to act as a solvent and dissolve at least the wood sugars 150.

Optionally, circulation of the opaque mixture 200 may occur prior to the application of the constant RF energy, optional block 918. Decision 918 checks to see if the opaque mixture is being circulated. If the evaluation is “No”, the circulation system is engaged, block 920. If the evaluation is “Yes”, a second evaluation is performed to determine if the cycle of rapid aging is complete, decision 922. For at least one embodiment, the cycle for rapid aging is based on time, such as an hour.

If the evaluation of decision 922 is “No,” the cycle continues with the application of RF energy, returning to block 916. If the evaluation of decision is “Yes,” the application of RF energy is halted, and the opaque mixture 200 is oxygenated, block 924. As discussed above, for at least one embodiment, an additional quantity of water may be optionally added to drop the proof from a first proof to a second proof. For such an embodiment, the cycle evaluation may have a “Partial” state, indicating it is now the proper time to add the additional water, block 926

Following the addition of the water at block 926, the method returns to block 916 for continued application of RF energy 300. After the oxygenation of block 924, the method continues with the filtering of the opaque mixture 200 to provide the now aged distilled ethyl alcohol spirit for bottling, packaging, shipping, and consumption, block 926

Alcoholic beverages are often an acquired taste, and distilled alcoholic spirits often even more so. What is pleasing and enjoyable to one person may not be to another. However, even within the spectrum of different viewpoints and expectations, there are some general norms which have been established. Is the color rich of caramel or thin like aged varnish? Are there tasting notes of vanilla, nutmeg, peatmoss? Is the alcohol profile intense at first sip and smooth at the finish, or is there an intensifying heat or burn?

Subjective though these criteria may be, there is often a common desire among people to find ways to convey a mutual understanding and appreciation of a thing, and an understood desire for one person's view and description to be accepted and perhaps even repeated by another person. This definitely applies to distilled spirits, and has permitted the development of an extensive system of comparisons and competitions for the ranking and evaluations of comparative distilled spirits.

With respect to the present invention of RAS 100 and the described process of rapid aging, multiple respected persons within the distilled spirits industry have agreed that an embodiment of the aging process performed over about twenty-four hours provides a rapidly aged distilled spirit that is essentially on par, as in equivalent to, a spirit resulting from ten years of traditional barrel aging. With respect to the issues of time and actual expenses for storage, care, maintenance, etc. . . . and even loss through evaporation, the present invention may be easily appreciated as a highly advantageous alternative.

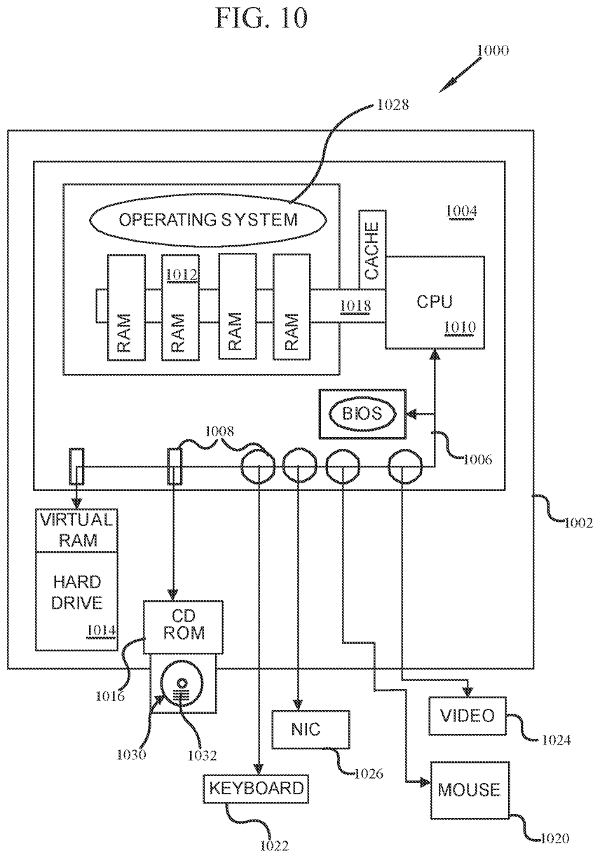

To expand upon the initial suggestion of at least one computer 126 being adapted to control RAS 100, and potentially the computer control system for the RF generator 116, FIG. 10 is a high level block diagram of an exemplary computer system 1000 such as may be provided for the at least one computer or other computing elements whether provided as distinct individual systems or integrated together in one or more computer systems.

Computer system 1000 has a case 1002, enclosing a main board 1004. The main board 1004 has a system bus 1006, connection ports 1008, a processing unit, such as Central Processing Unit (CPU) 1010 with at least one microprocessor (not shown) and a memory storage device, such as main memory 1012, hard drive 1014 and CD/DVD ROM drive 1016.

Memory bus 1018 couples main memory 1012 to the CPU 1010. A system bus 1006 couples the hard disc drive 1014, CD/DVD ROM drive 1016 and connection ports 1008 to the CPU 1010. Multiple input devices may be provided, such as, for example, a mouse 1020 and keyboard 1022. Multiple output devices may also be provided, such as, for example, a video monitor 1024 and a printer (not shown). As computer system 1000 is intended to be interconnected with other computer systems in the CSE 100 a combined input/output device such as at least one network interface card, or NIC 1026 is also provided.

Computer system 1000 may be a commercially available system, such as a desktop workstation unit provided by IBM, Dell Computers, Gateway, Apple, or other computer system provider. Computer system 1000 may also be a networked computer system, wherein memory storage components such as hard drive 1014, additional CPUs 1010 and output devices such as printers are provided by physically separate computer systems commonly connected together in the network.

Those skilled in the art will understand and appreciate that the physical composition of components and component interconnections are comprised by the computer system 1000, and select a computer system 1000 suitable for one or more of the computer systems incorporated in the formation and operation of CSE 100.

When computer system 1000 is activated, preferably an operating system 1028 will load into main memory 1012 as part of the boot strap startup sequence and ready the computer system 1000 for operation. At the simplest level, and in the most general sense, the tasks of an operating system fall into specific categories, such as, process management, device management (including application and User interface management) and memory management, for example. The form of the computer-readable medium 1030 and language of the program 1032 are understood to be appropriate for and functionally cooperate with the computer system 1000.

Moreover, variations of computer system 1000 may be adapted to provide the physical elements of one or more components comprising the at least one computer 126, the control systems (if any) within the RF generator 116, and other such devices or elements incorporated as part of RAS 100 as may be desired and appropriate for the methods and systems for the rapid aging of a distilled ethyl alcohol with RF energy as set forth herein.

It is to be understood that changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A method for the rapid aging of distilled ethyl alcohol, comprising:
providing a vessel having at least one aperture suitable for the introduction of radio frequency (RF) energy at a preselected frequency selected to pass through transparent material and be absorbed by opaque material, the vessel having at least one liquid circulating system structured and arranged to circulate liquid from a lower portion of the vessel to an upper portion of the vessel, the at least one aperture coupled to an RF generator structured and arranged to provide the RF energy at the preselected frequency;
providing a substantially transparent distilled ethyl alcohol having a first proof;
providing at least one unit of wood having a plurality of capillaries containing wood sugar;
combining the distilled ethyl alcohol and the at least one unit of wood to provide an opaque mixture, the opaque mixture disposed within the vessel, the opaque mixture having a surface disposed below the at least one aperture;
applying by the RF generator through the aperture, a constant RF energy at the preselected frequency, the applied constant RF energy heating the opaque mixture to expand the plurality of capillaries, the heated and expanded capillaries absorbing the alcohol of the distilled ethyl alcohol, the absorbed alcohol dissolving at least the wood sugars into the distilled ethyl alcohol to rapidly age the distilled ethyl alcohol.

2. The method according to claim 1, wherein the at least one unit of wood further includes resins, the absorbed alcohol dissolving the resins into the distilled ethyl alcohol.

3. The method according to claim 2, wherein the dissolving of the wood sugars and resins produces congeners within the opaque mixture, the opaque mixture being oxygenated to release the congeners from the opaque mixture, the released congeners vented from the vessel.

4. The method according to claim 2, wherein the constant RF energy passes through the distilled ethyl alcohol for application upon the resins and at least one unit of wood.

5. The method according to claim 1, wherein the predetermined frequency of constant RF energy is in a range selected to impinge upon opaque material within the vessel more than dipoles of the alcohol or water.

6. The method according to claim 1, wherein the opaque mixture is circulated to continuously refresh the surface as the constant RF energy is applied, thereby ensuring opaque elements of the opaque mixture proximate to the surface receive high concentration of the predetermined frequency of the constant RF energy.

7. The method according to claim 1, wherein the constant RF energy fosters the development of esters within the opaque mixture.

8. The method according to claim 1, wherein the at least one unit of wood is chipped and toasted.

9. The method according to claim 1, wherein the opaque mixture is rested for about 24 hours to saturate the at least one unit of wood prior to the application of the constant RF energy.

10. The method according to claim 1, wherein the ratio of the distilled ethyl alcohol to the at least one unit of wood in the opaque mixture within the vessel is between about 2.4 oz to 4.1 oz of wood per gallon.

11. The method according to claim 1, wherein the predetermined frequency is in the range from 3 MHz to 915 MHz.

12. The method according to claim 1, wherein the RF generator is coupled to the at least one aperture by at least one waveguide.

13. The method according to claim 1, wherein the opaque mixture is circulated within the vessel during the rapid aging process.

14. The method according to claim 1, wherein the applied constant RF energy results in the opacity of the opaque mixture increasing as the resulting heat generated from the applied constant RF energy breaks down the at least one unit of wood.

15. The method according to claim 1, wherein the application of constant RF energy generates a region of high temperature proximate to opaque elements of the opaque mixture.

16. The method according to claim 1, wherein the aged distilled ethyl alcohol is filtered.

17. The method according to claim 1, wherein the first proof does not exceed about 125 proof.

18. The method according to claim 1, wherein after a first period of time, a quantity of water is added to the opaque mixture to provide a second proof lower than the first proof, the additional quantity of water further dissolving the wood sugars within the opaque mixture.

19. The method according to claim 1, wherein the second proof is at about 113 proof.

20. The method according to claim 1, wherein the application of constant RF energy generates a temperature greater than 60 degrees Celsius.

21. The method according to claim 1, wherein the application of constant RF energy generates a temperature of about 65.5 degrees Celsius.

22. The method according to claim 1, wherein the method rapidly ages the distilled ethyl alcohol in about 24 hours to the equivalent of about 10 years of traditional barrel aging.

23. A method for the rapid aging of distilled ethyl alcohol, comprising:
providing a vessel having at least one aperture suitable for the introduction of radio frequency (RF) energy at a preselected frequency into the vessel;
providing a distilled ethyl alcohol having a first proof;
providing at least one unit of wood having a plurality of capillaries containing at least wood sugar and resins;
combining the distilled ethyl alcohol and at least one unit of wood to provide an opaque mixture, the opaque mixture disposed within the vessel, the opaque mixture having a surface disposed below the at least one aperture; and
applying a constant RF energy through the aperture at the preselected frequency, the applied constant energy heating the opaque mixture to expand the plurality of capillaries, the heated and expanded capillaries absorbing the alcohol of the distilled ethyl alcohol, the absorbed alcohol dissolving at least a portion of the wood sugars and resins into the distilled ethyl alcohol to rapidly age the distilled ethyl alcohol.

24. The method according to claim 23, wherein the dissolving of the wood sugars and resins produces congeners within the opaque mixture, the opaque mixture being oxygenated to release the congeners from the opaque mixture, the released congeners vented from the vessel.

25. The method according to claim 23, wherein the constant RF energy passes through the distilled ethyl alcohol for application upon the resins and at least one unit of wood.

26. The method according to claim 23, wherein the predetermined frequency of constant RF energy is in a range selected to impinge upon opaque material within the vessel more than dipoles of the alcohol or water.

27. The method according to claim 23, wherein the constant RF energy further induces rapid development of esters from dissolved wood sugars and resins.

28. The method according to claim 23, wherein the vessel further includes at least one liquid circulating system structured and arranged to circulate liquid from a lower portion of the vessel to an upper portion of the vessel, the opaque mixture being circulated to continuously refresh the surface as the constant RF energy is applied, thereby ensuring opaque elements of the opaque mixture proximate to the surface receive high concentration of the predetermined frequency of the constant RF energy.

29. The method according to claim 23, wherein the at least one unit of wood is chipped and toasted.

30. The method according to claim 23, wherein the opaque mixture is rested for about 24 hours to saturate the at least one unit of wood prior to the application of the constant RF energy.

31. The method according to claim 23, wherein the ratio of the distilled ethyl alcohol to the at least one unit of wood in the opaque mixture within the vessel is between about 2.4 oz to 4.1 oz of wood per gallon.

32. The method according to claim 23, wherein the predetermined frequency is in the range from 3 MHz to 915 MHz.

33. The method according to claim 23, wherein the application of constant RF energy generates a region of high temperature proximate to opaque elements of the opaque mixture.

34. The method according to claim 23, wherein the aged distilled ethyl alcohol is filtered.

35. The method according to claim 23, wherein the first proof does not exceed 125 proof.

36. The method according to claim 23, wherein after a first period of time, a quantity of water is added to the opaque mixture to provide a second proof lower than the first proof, the additional quantity of water further dissolving the wood sugars within the opaque mixture.

37. The method according to claim 23, wherein the second proof is at about 113 proof.

38. The method according to claim 23, wherein the application of constant RF energy generates a temperature greater than 60 degrees Celsius.

39. The method according to claim 23, wherein the application of constant RF energy generates a temperature of about 65.5 degrees Celsius.

40. The method according to claim 23, wherein the method rapidly ages the distilled ethyl alcohol in about 24 hours to the equivalent of about 10 years of traditional barrel aging.

41. A system for rapid aging of a distilled ethyl alcohol, comprising:
a vessel having at least one aperture suitable for the introduction of radio frequency (RF) energy at a preselected frequency selected to pass through transparent material and be absorbed by opaque material, the vessel having at least one liquid circulating system structured and arranged to circulate liquid from a lower portion of the vessel to an upper portion of the vessel;
an RF generator structured and arranged to provide the predetermined frequency;
at least one waveguide disposed between the RF generator and the vessel, the at least one waveguide structured and arranged to convey the generated predetermined frequency from the RF generator to the at least one aperture; and
an oxygenator structured and arranged to dispose oxygen within a liquid disposed within the vessel and outgas congeners from the liquid, the vessel further providing at least one vent structured and arranged to vent the outgassed congeners.

42. The system of claim 41, wherein the RF generator is structured and arranged to provide the predetermined frequency is in the range from 3 MHz to 915 MHz.

43. The system of claim 41, wherein the RF generator is structured and arranged to provide the predetermined frequency in a range selected to impinge upon opaque material within the vessel more than dipoles of alcohol or water disposed within the vessel.

44. The system of claim 41, wherein the predetermined frequency generates a temperature greater than 60 degrees Celsius within the opaque materials impinged upon by the continuous RF energy.

45. The system of claim 41, wherein the predetermined frequency generates a temperature of about 65.5 degrees Celsius within the opaque materials impinged upon by the continuous RF energy.

46. The system of claim 41, wherein the system rapidly ages the distilled ethyl alcohol in about 24 hours to the equivalent of about 10 years of traditional barrel aging.

47. The system of claim 41, wherein the system further includes a filter structured and arranged to filter the resulting aged distilled ethyl alcohol.
